(19) United States
(12) Patent Application Publication
(10) Pub. No.: US 2019/0002760 A1
(43) Pub. Date: Jan. 3, 2019

(54) APPARATUS AND METHOD FOR USING SILICON QUANTUM DOTS AS GRANULATING MATERIAL FOR THE FORMATION OF PMMA ACRYLIC BEADS

(71) Applicants: Sharon Johnson, Lino Lakes, MN (US); Fredrik Johnson, Lino Lakes, MN (US)

(72) Inventors: Sharon Johnson, Lino Lakes, MN (US); Fredrik Johnson, Lino Lakes, MN (US)

(21) Appl. No.: 16/021,791

(22) Filed: Jun. 28, 2018

Related U.S. Application Data
(60) Provisional application No. 62/526,767, filed on Jun. 29, 2017.

(51) Int. Cl. C09K 11/08

(52) U.S. Cl. CPC C09K 11/08

(57) ABSTRACT

A method and an apparatus for forming beads or powders includes using quantum dots as a granulating material (nucleation donor) in a suspension polymerization process. The resulting beads or powders can be formed into shapes.

This application claims benefit of U.S. Provisional Application No. 62/526,767, filed on Jun. 29, 2017 and which application is incorporated herein by reference. A claim of priority is made.

### TECHNICAL FIELD

Various embodiments described herein relate to an apparatus and method for using silicon quantum dots as a granulating material. More specifically, the silicon quantum dots will be used as a granulating material for the formation of PMMA acrylic beads.

### SUMMARY OF THE INVENTION

Certain materials are used to manufacture other objects. Certain polymers are formed into beads and powders. These beads and powders can then be used to produce sheets and shapes of polymer material, such as an acrylic material. Generally, the beads and powders are expensive to manufacture which in turn results in high costs for some of the manufactured items made using this technique. Manufacturers are always looking for a less expensive ways to manufacture raw materials.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

Quantum dots are very small semiconductor particles, and are generally only several nanometers in size. Quantum dots are so small that their optical and electronic properties differ from those of larger particles. Many types of quantum dot will emit light of specific frequencies if electricity or light is applied to them. The frequencies of light can be precisely tuned by changing the dots' size, shape and material. Quantum dots can be synthesized using various methods. The methods include colloidal synthesis, plasma synthesis and the like. Quantum dots can be manufactured in high numbers. As mentioned previously, the quantum dots can be made from different materials.

In one embodiment, quantum dots made from silicon are used as a granulating material for the formation of Poly(methyl methacrylate) (PMMA) acrylic beads. The quantum dots used as a granulating material are essentially nucleation donors. The quantum dots are used in a suspension polymerization process. PMMA beads can be formed using the quantum dots as nucleation donors.

Similarly, quantum dots of silicon can also be used to form powder materials. It is also thought that other polymer beads and powders can also be formed using this process. The beads formed in this manner can be used in any current polymer powder forming process to produce sheets and shapes of acrylic material making it commercially viable to create transparent and translucent luminescent solar concentrating “windows” and other shapes. The PMMA beads can be formed into indirect-bandgap semiconductor nanostructures as highly emissive silicon quantum dots. These can be formed into translucent luminescent solar concentrating windows and other shapes to form luminescent solar concentrators (LSCs).

Quantum beads made of materials other than silicon may also have application to form beads and powders that can be used in various further manufacturing processes.

In summary, silicon quantum dots are used as a granulating material (nucleation donor) used in suspension polymerization for the formation of PMMA beads and other polymer beads and powder materials. The beads formed in this manner can be used in any current polymer powder forming process to produce sheets and shapes of acrylic material making it commercially viable to create transparent and translucent luminescent solar concentrating “windows” and other shapes.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed:

1. A method for forming beads or powders includes using quantum dots as a granulating material (nucleation donor) in a suspension polymerization process.

2. The method of claim 1 wherein the quantum dots are made from silicon.
